(19) United States
(12) Patent Application Publication
(10) Pub. No.: US 2013/0287883 A1
(43) Pub. Date: Oct. 31, 2013

(54) Injection-Moulding Machine with a Shut-Off Needle

(71) Applicants: Stefan Schweininger, Wiesbaden (DE); Christian Wagner, Mainz (DE)

(72) Inventors: Stefan Schweininger, Wiesbaden (DE); Christian Wagner, Mainz (DE)

(73) Assignee: MHT MOLD & HOTRUNNER TECHNOLOGY AG, Hochheim (DE)

(21) Appl. No.: 13/979,405

(22) PCT Filed: Jan. 2, 2012
(86) PCT No.: PCT/EP12/50008

§ 371 Date: Jul. 12, 2013

(30) Foreign Application Priority Data
Jan. 12, 2011 (DE) 10 2011 002 586.3

(51) Int. Cl. B29C 45/23

(52) U.S. Cl. CPC B29C 45/231
USPC 425/547

(57) ABSTRACT

This relates to an injection-moulding machine comprising a hot runner for feeding a melt into a mould, a shut-off needle for closing or opening the hot runner, a piston connected to the shut-off needle, dividing the housing into first and second chambers, and a covering plate with a first and a second fluid 72 outlet, wherein the housing has a first fluid inlet, which is in connection with the first chamber, and a second fluid inlet, which is in connection with the second chamber, which are arranged in such a way that fluid can be transferred via the first fluid outlet of the covering plate into the first fluid inlet of the housing and fluid can be transferred via the second fluid inlet of the housing, and so fluid can be applied to the piston from both sides.

The present invention relates to an injection-moulding machine with a hot runner for feeding a plasticised melt into a mould. Here, a shut-off needle is provided for optionally closing or opening the hot runner, the shut-off needle being connected to a piston which is arranged in a housing with an opening and to which a fluid can be applied on both sides. Thus, with the aid of the fluid the piston and hence the shut-off needle connected to the piston can be moved inside the housing in order to close or open the hot runner in relation to the mould.

The piston divides the housing into a first and a second chamber. In addition, a covering plate is provided which has a first and a second fluid outlet, the housing exhibiting a first fluid inlet which is connected to the first chamber, and a second fluid inlet which is connected to the second chamber, the covering plate and the housing being arranged in such a way that fluid can be transferred through the first fluid outlet of the covering plate into the first fluid inlet of the housing and fluid can be transferred through the second fluid outlet of the covering plate into the second fluid inlet of the housing so that fluid can be applied to both sides of the piston, the covering plate, the housing and the piston together forming the first chamber.

The covering plate closes the opening of the housing. One such injection-moulding machine is described in U.S. Pat. No. 4,173,448 for example.

In the form of embodiment shown the covering plate exhibits recesses into which the housing projects so that the housing is arranged partly inside the recess.

As the generally heated plasticised melt is fed through the hot runner and a hot runner block accommodating the hot runner undergoes considerable expansion due to a large number of shut-off needles each connected to a piston arranged therein, the precise position of the shut-off needle relative to the covering plate changes when the injection-moulding machine is set in operation because of the thermal expansion of the housing and the hot runner block associated with the increase in temperature.

This leads firstly to the housing expanding in the direction of the covering plate when the hot runner block and the housing connected to it are heated. In addition, the housing is also moved perpendicularly to the axis of the needle so that when selecting the dimensions of the fluid outlet opening of the covering plate and the fluid inlet opening of the housing, it is important to make sure that these line up with one another both when cold and when at operating temperature in order to guarantee a transfer of fluid from the covering plate into the housing at all temperatures.

In U.S. Pat. No. 4,173,448 named initially a plurality of channels are formed in the wall of the housing which connect the second fluid inlet of the housing to the second chamber. The fluid inlet of the housing is formed by a circular groove in the bottom of which the channels terminate. To ensure that the fluid outlet of the covering plate and the fluid inlet of the housing at least partly line up with one another over a wide temperature range so that a transfer of fluid is guaranteed, the wall of the housing must be made relatively thick in order to be able to form correspondingly large channel bores. However, if the housing and the covering plate are not aligned perfectly with one another, a change in temperature can prevent a satisfactory transfer of fluid occurring between the covering plate and the housing, which can lead to reduced or even non-existent control of the shut-off valve.

Departing from the prior art as described, it is therefore the object of the present invention to provide an injection-moulding machine of the kind named initially with which an optimum transfer of fluid between the covering plate on the one hand and the housing on the other is guaranteed even with fairly large changes in the temperature of the hot runner block.

According to the invention, this object is achieved in that the second fluid inlet opening of the housing and the second fluid outlet opening of the covering plate differ in their cross-section areas and/or are located different distances from the axis of the shut-off needle, an adapter element being provided with a fluid inlet opening and a fluid outlet opening and configured in such a way that the fluid provided by the covering plate through the second fluid outlet opening can be passed through the fluid inlet opening into the adapter element and through the fluid outlet opening from the adapter element into the second fluid inlet opening of the housing.

The adapter element according to the invention can guarantee the transfer of fluid even with fairly large changes in temperature. So, for example, the fluid inlet opening of the adapter element can have a much greater cross-section than the second fluid outlet opening of the covering plate. When the adapter element is connected to the housing, this means that the adapter element and the housing together move relative to the covering plate when the hot runner block is heated. However, because of the large cross-section of the fluid inlet of the adapter element, a relative movement does not lead to no fluid being transferrable any more.

For the connection of the adapter element to the housing, in one preferred form of embodiment provision can be made for the adapter element to be connected to the housing in a form-locking manner in a direction perpendicular to the axis of the shut-off needle. Thus, for example, the adapter element can exhibit a base part extending essentially perpendicular to the needle axis and a hollow cylindrical extension running essentially parallel to the needle axis. This extension can either at least partly surround the housing or be arranged at least partly inside the housing. The hollow cylindrical extension and the housing are configured in such a way that a relative movement perpendicular to the needle axis between the housing on the one hand and the adapter element on the other is not possible when the extension is mounted or inserted. In other words the form-locking connection is provided by the hollow cylindrical extension.

To guarantee as space-saving a design as possible, in one preferred form of embodiment provision is made for the piston to be arranged at least partly inside the hollow cylindrical extension.

In a further preferred form of embodiment provision is also made for the second fluid inlet opening of the housing to be formed by the inner wall of the housing and the outer wall of the extension. In other words in this case the housing does not exhibit a channel lying inside the housing connecting the second outlet opening of the adapter element to the second chamber. Instead the fluid channel is formed between the hollow cylindrical extension and the housing.

For this, the extension can exhibit on its outside at least one and preferably a large number of grooves running essentially parallel to the needle axis.

The fluid is passed into the second chamber or able to escape from the second chamber inside these grooves.

In a further particularly preferred form of embodiment the second fluid outlet opening of the covering plate lies nearer to the needle axis than the fluid inlet opening of the housing.

In addition, it can be advantageous when the fluid inlet opening of the adapter element and the fluid outlet opening of the adapter element differ in their cross-section areas and/or are located different distances from the axis of the shut-off needle.

In order to simplify the production of the housing further, it can also be advantageous if the housing exhibits an essentially hollow cylindrical casing part and a bottom part, the bottom part exhibiting a passage for the needle.

Here the bottom part advantageously exhibits an essentially cylindrical projection the outside diameter of which essentially corresponds to the inside diameter of the casing part.

Furthermore, the covering plate, hot runner block and housing can be arranged in such a way that at a first temperature of the hot runner block a gap is left between the housing and the covering plate, and at a second temperature of the hot runner block which is higher than the first temperature the housing comes into contact with the covering plate in such a way that the covering plate closes the opening of the housing due to the thermal expansion of the hot runner block and/or housing, and preferably a flexible seal is provided between the housing and the covering plate, this seal being configured in such a way that the covering plate closes the opening of the housing in a position in which the covering plate and the housing are a distance from one another.

It is obvious that for this the adapter element must be regarded as part of the housing. Therefore the flexible seal can also be provided between the adapter element as part of the housing and the covering plate.

In other words the flexible seal ensures that the opening of the housing can be closed by the covering plate although the distance between the housing and the covering plate reduces further when the hot runner block and the housing are heated further.

The flexible seal also allows a relative movement between the covering plate on the one hand and the housing on the other perpendicular to the needle axis as the flexible seal is able to slide on the surface of the covering plate or on the end of the housing to a limited degree.

For example, the housing and/or the covering plate can exhibit a corresponding groove into which the flexible seal, e.g. an O-ring, can be fitted. Here the flexible seal and the groove are best configured in such a way that on reaching the operating temperature the housing comes into contact with the covering plate directly so that in this situation the flexible seal does not have to perform any sealing function any more.

Furthermore, two flexible seals can be provided between the housing and the covering plate, the two flexible seals being arranged in such a way that fluid can only be fed into the first housing chamber through the first fluid feed of the covering plate and fluid can only be fed into the second housing chamber through the second fluid feed of the covering plate.

In other words the two flexible seals are arranged in such a way that the first and the second fluid feeds of the covering plate are separated from one another by one of the flexible seals.

For example the flexible seals can be formed by two O-rings arranged concentrically with one another. The first fluid feed of the covering plate is then arranged for example in such a way that the fluid feed takes place inside the inner O-ring while the second fluid feed is arranged in such a way that the fluid feed takes place between the inner O-ring and the outer O-ring.

Furthermore the adapter element can exhibit a piston stop face which is arranged in such a way that the piston bears on the piston stop face in one of its maximum positions. The application of the fluid to both sides of the piston causes the piston to move to and fro inside the housing, through which the shut-off needle can be moved from the open position into the closed position. The piston stop face ensures that sufficient space remains between the piston on the one hand and the adapter element or covering plate on the other, even in the piston position in which the piston is closest to the adapter element, so that the effective area to which the fluid can be applied does not drop below a minimum amount.

Further advantages, features and possible applications of the present invention will become apparent from the following description of a few preferred forms of embodiment and the attached figures in which:

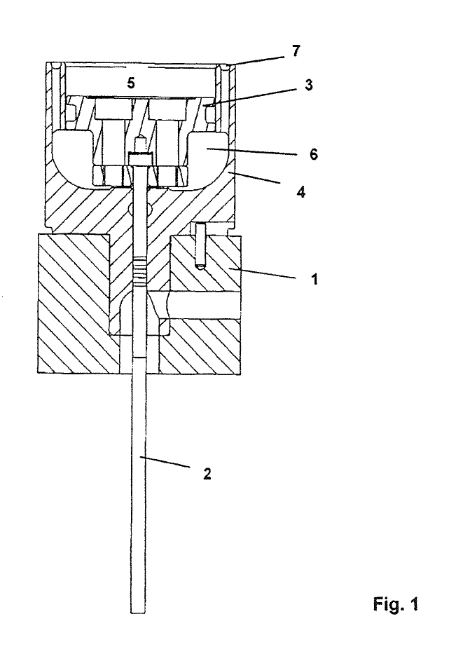

FIG. 1 shows a sectional view of a housing according to the prior art;

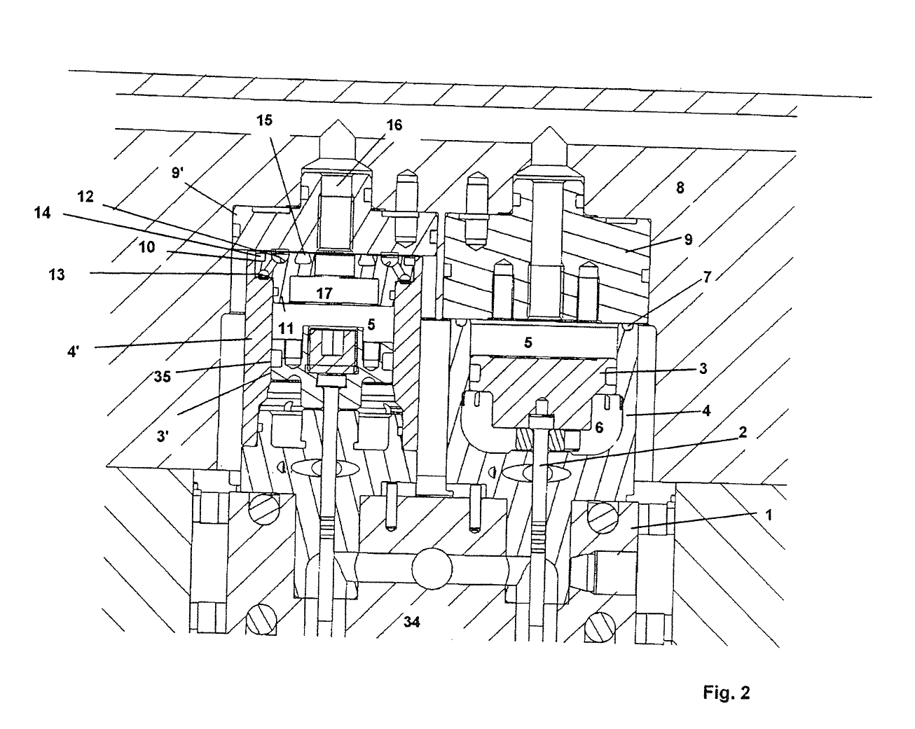

FIG. 2 shows a sectional view in which a form of embodiment according to the prior art is compared with the first form of embodiment of the invention;

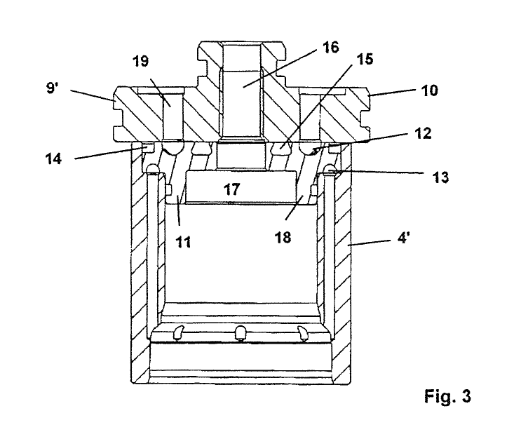

FIG. 3 shows a view of the first form of embodiment;

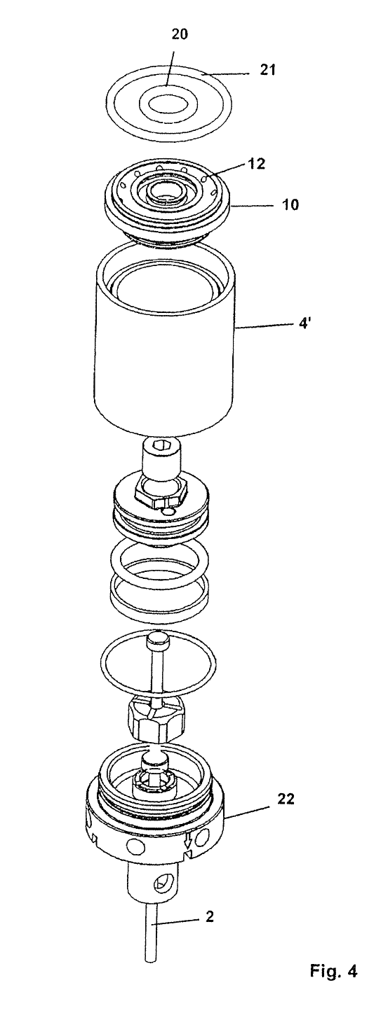

FIG. 4 shows an exploded view of the first form of embodiment of the invention;

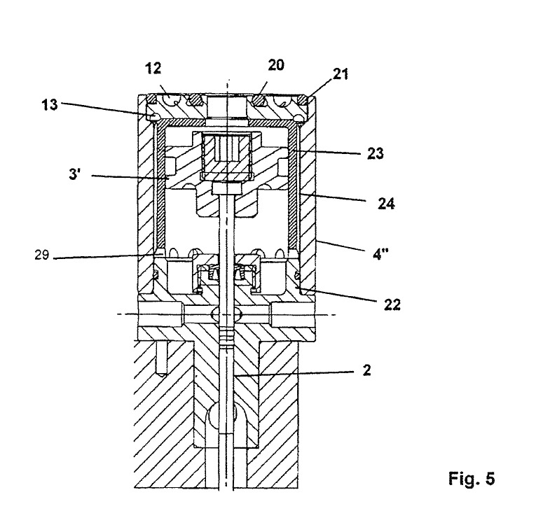

FIG. 5 shows a sectional view of a second form of embodiment of the invention;

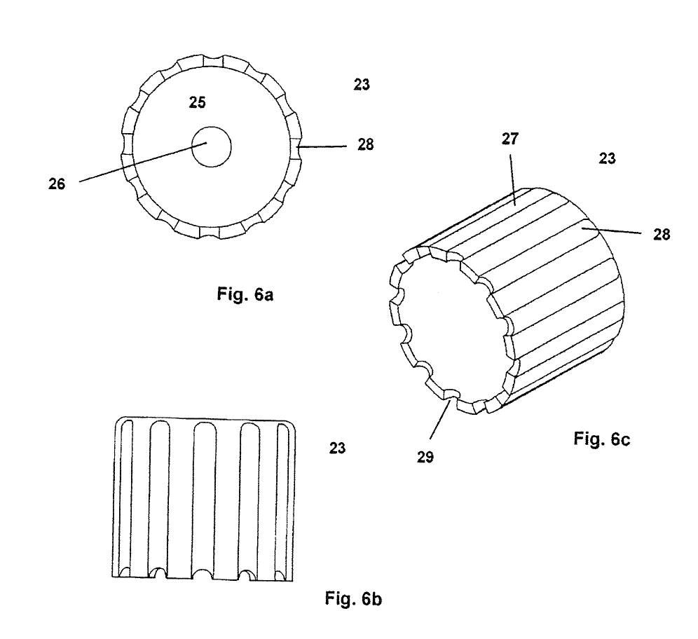

FIGS. 6a to 6c show three views of the bell-shaped element of the second form of embodiment of the invention;

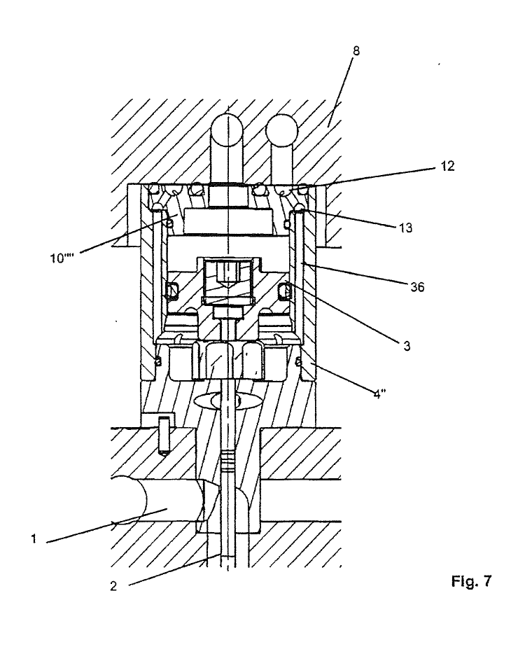

FIG. 7 shows a sectional view of a third form of embodiment of the invention;

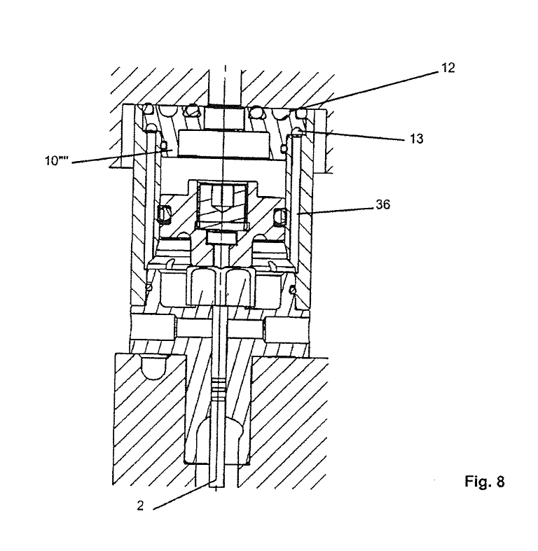

FIG. 8 shows a further sectional view of the third form of embodiment of the invention;

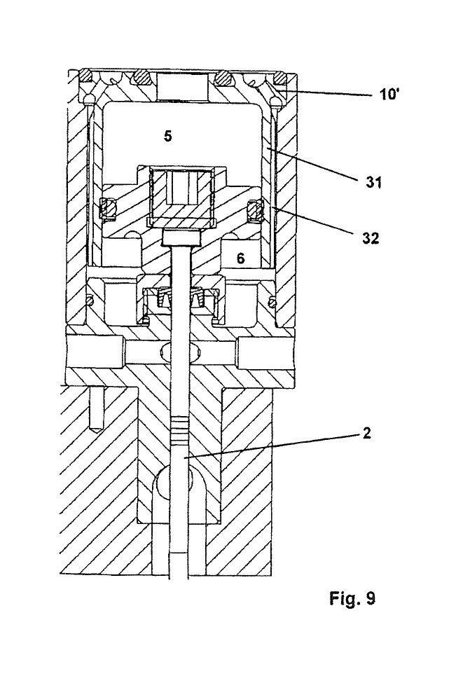

FIG. 9 shows a view of a fourth form of embodiment of the invention;

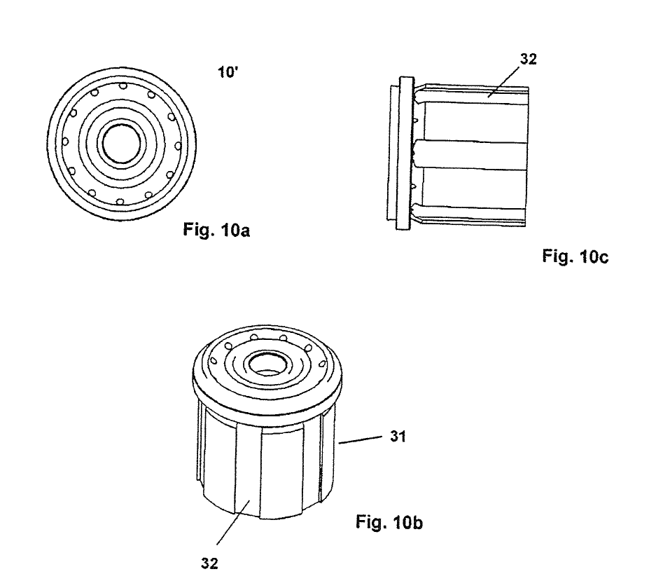

FIGS. 10a to 10c show three views of the adapter element of the fourth form of embodiment of the invention according to FIG. 9;

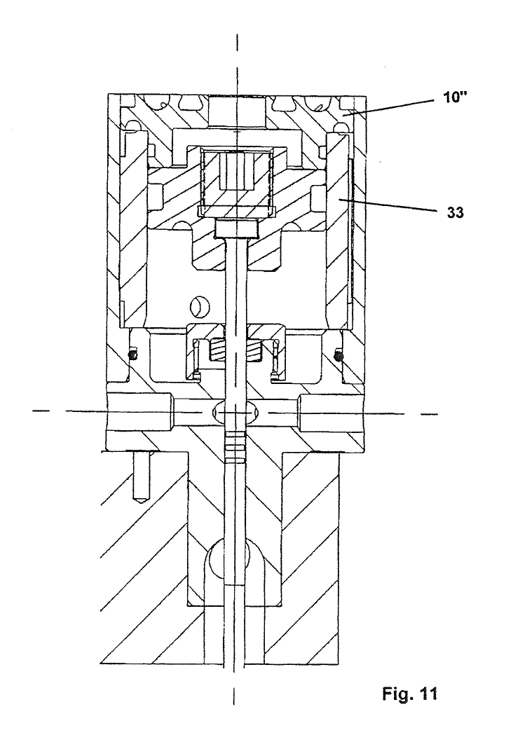

FIG. 11 shows a view of a fifth form of embodiment of the invention;

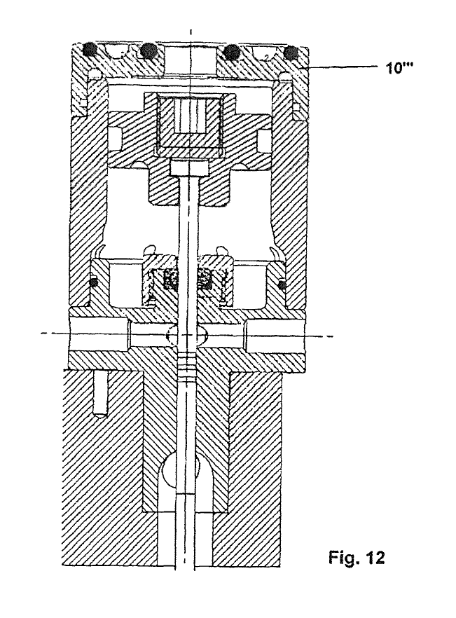

FIG. 12 shows a view of the sixth form of embodiment of the invention.

FIG. 1 shows a part of an injection-moulding machine according to the prior art. The hot runner block 1, the outlet of which can be opened or closed with the aid of the shut-off needle 2, is clearly visible. The shut-off needle 2 is connected to the piston 3 which is guided inside a housing 4 and this is divided into a first housing chamber 5 and a second housing chamber 6. A fluid can be applied to the piston 3 from above through the first housing chamber or through the fluid inlet 7 and the lower housing chamber 6 in order to move the piston 3 upwards and downwards inside the housing 4 and so cause the shut-off needle to close or open.

FIG. 2 shows on the right-hand side the form of embodiment according to the prior art shown in FIG. 1. On the left-hand side it shows a first form of embodiment of the invention. The covering plate 8 is arranged above the housing 4. Formed in the covering plate 8 there is a recess into which the housing 4 projects. The covering plate 4 is connected to a covering element 9. Through this covering element 9 a fluid can be supplied optionally to either the first housing chamber 5 or the second housing chamber 6 in order to move the piston 3 inside the housing 4. The adapter element can also be formed in one piece with the covering plate.

In the position shown on the right in FIG. 2 the piston 3 is in its lower position, i.e. the valve has closed the hot runner. To move the piston 3 upwards and so move the shut-off needle 2 into the open position, fluid must be introduced through the covering element 9 through the fluid inlet 7 into the housing 4. The fluid inlet 7 of the housing 4 is connected to the lower housing chamber 6 through a channel inside the wall (not visible in the figure). So if fluid is fed through this fluid channel, the pressure in the lower chamber 6 rises and the piston 3 moves upwards in FIG. 1, through which the upper housing space 5 is reduced in size until the piston 3 bears on the covering element 9.

Extreme differences in temperature prevail in the tool shown when in operation. While the hot runner block 34 through which the plasticised heated melt is fed works at a high temperature (greater than 250° C.), the covering plate 8 is usually cooled and therefore works at a much lower temperature (around 20° C.).

The high temperature differences mean that the thermal expansion of the individual elements must be borne in mind. Therefore the dimensions chosen for the housing 4 are such that it does not come into contact with the covering element 9 when it is cold, i.e. when the hot runner block 34 and the housing 4 still have not reached operating temperature. So, in this situation the covering element 9 is not able to close the housing 4, and the shut-off needle 2 cannot be controlled by feeding fluid. Consequently, before the start of the injection-moulding operation, the hot runner block 34 must be heated. This causes the material to expand and the gap between the housing 4 on the one hand and the covering element 9 on the other is reduced until the housing 4 is resting on the covering element 9 and pressed against it. As a result the opening in the housing 4 is closed by the covering element 9. In this state the piston 3 and hence the shut-off needle 2 can be controlled through appropriate fluid control through the covering element 9.

To allow control of the shut-off needle 2 at temperatures below the final operating temperature, the housing 4 is designed in such a way that it comes into contact with the covering element 9 at a temperature lying well below the operating temperature. Therefore, when the hot runner block 34 is heated further to the operating temperature, the housing 4 is pressed against the covering element 9 with great force. Consequently, considerable forces must be contained.

As generally a large number of shut-off needles are arranged next to one another inside the hot runner block 34, the expansion of the hot runner block 34 in the transverse direction, i.e. transversely to the shut-off needle axis, also plays a part so that in some circumstances deformation or tilting of the housing can occur when the housing 4 has already come into contact with the covering element 9 and a relative movement takes place between the housing 4 and the covering element 9 due to further heating of the hot runner block 34.

The view shown on the left in FIG. 2 shows a first form of embodiment of the invention. Here as well, a piston 3′, which is connected to a shut-off needle 2, is guided inside a housing 4′ and divides the hollow space inside the housing 4′ into two part spaces 5 and 6. To seal the two part spaces, the piston exhibits a circumferential groove 35 into which a seal can be fitted.

Both the upper chamber 5 and the lower chamber 6 can optionally be supplied with a fluid, i.e. pressurised, in order to cause the piston 3′ inside the housing 4′ to move upwards or downwards so as to move the shut-off needle 2 from its open position into the closed position and back again.

Here the housing 4′ exhibits an adapter element 10 which partly closes the opening of the housing 4′. This adapter element 10 exhibits an inner essentially circular groove 15 and an outer essentially circular groove 14. A flexible seal, in the present case an O-ring, is fitted into these grooves (not shown). This seal protrudes beyond the side of the adapter element 10 remote from the piston 3′ so that it provides a seal between the adapter element 10 on the one hand and the covering element 9′ on the other, even when the adapter element 10 and the covering element 9′ are still not touching. Therefore this measure ensures that a seal is provided between the housing and the covering element at temperatures lying well below the operating temperature, so that effective control of the shut-off needle 2 is possible. At the latest by the time the operating temperature of the hot runner block 34 is reached, the housing 4′ has expanded so that it comes into contact with the covering element 9′. In this situation, which is shown in FIG. 1, the flexible seals fitted into the grooves 14 and 15 not longer perform any sealing function.

Through the covering element 9′ fluid can be fed on the one hand centrally through the first fluid outlet 16 into the first fluid inlet 17 of the adapter element 10 and also through the second fluid outlet 19 into the second fluid inlet 12 of the adapter element. It can be seen that the second fluid outlet 19 of the covering element 9′ is arranged nearer the axis of the needle than the second fluid inlet 12 of the housing 4′. In addition the second fluid outlet 19 of the covering element 9′ is designed with a larger cross-section than the second fluid inlet 12 of the housing 4′. Consequently the adapter element 10 exhibits a second fluid inlet 12 which has a greater cross-sectional area and is located radially more towards the interior and a second fluid outlet 13 which has a smaller cross-sectional area and is located radially more towards the exterior.

The adapter element 10 is connected to the housing 4′ in a form-locking manner so that the adapter element 10 together with the housing 4′ can move relative to the covering element 9′. In the case of a movement perpendicular to the needle axis, because of the adapter element 10 a movement does not lead to an immediate interruption in the supply of fluid, as is the case after only a tiny transverse movement in the form of embodiment according to the prior art, which is shown on the right in FIG. 2.

Instead a transverse movement is allowed yet a transfer of fluid is guaranteed.

FIG. 3 shows an enlarged detail of the first form of embodiment of the invention. Here it can be seen clearly that the hollow cylindrical extension 11 provides a stop face 18. In addition it can be seen in the sectional view shown here that the second fluid outlet of the adapter element 10 is connected to a channel running inside the housing 4′ through which the fluid can be passed into the second chamber 6.

FIG. 4 shows an exploded view of the first form of embodiment of the invention. In this view it can be seen in particular that the housing 4′ consists of an essentially cylindrical element and a bottom element 22 which exhibits a passage for the shut-off needle 2. It can also be seen that the second fluid inlet 12 of the adapter element 10 consists of a circular groove in the base of which a series of channels terminate, connecting the second fluid inlet of the adapter element 10 to the second fluid outlet of the adapter element which also takes the form of a circular groove.

FIG. 5 shows a second form of embodiment of the invention. Unlike the first form of embodiment, here the adapter element additionally exhibits a cap or bell element 23. This can—but does not have to be connected to the adapter element 10. The cap element 23 is shown again in three different views in FIGS. 6a to 6c. It exhibits a cap bottom 25 and a circumferential casing face 27. In the bottom of the cap there is an opening 26 through which the fluid can be passed into the first chamber. The casing face 27 exhibits a series of grooves 28 which run axially, producing a channel between the cap element 23 and the housing 4′. This channel has been given the reference number 24 in FIG. 5.

On the side remote from the bottom part 25 the grooves 28 exhibit corresponding recesses 29 to the inside of the cap element which when assembled provide corresponding openings 29 to the second chamber 6, as can be seen in FIG. 5.

FIGS. 7 and 8 show two sectional views of a third form of embodiment of the invention. In this form of embodiment the covering element has been eliminated. Instead, the adapter element 10″″ engages directly with the covering plate 8. Thus the fluid can be passed directly from the covering plate 8 through the second fluid inlet opening 12 of the adapter element 10″″, through the second fluid outlet opening 13 of the adapter element 10″″ and the fluid channel 36 into the lower housing chamber.

FIG. 9 shows a fourth form of embodiment of the invention. Here the adapter element 10′ exhibits a hollow cylindrical element 31 which is formed in one piece and on its outside exhibits a large number of grooves 32, as can be seen in FIGS. 10a to 10b, so that a channel is produced between the covering element on the one hand and the housing on the other through which fluid can be conveyed into the second chamber 6. Therefore in this form of embodiment as well it is not necessary to provide a channel running inside the wall of the housing. As the hollow cylindrical element is held by the adapter element, it is not necessary for it to be supported on the housing so that the recesses on the side remote from the adapter element can be eliminated if a gap to the housing remains at the end of the hollow cylindrical element 31.

FIG. 11 shows a fifth form of embodiment of the invention. Here the housing wall is constructed in two parts, i.e. arranged inside the housing there is a cylindrical element 33 which exhibits corresponding grooves running axially on the outside. This form of embodiment also makes it possible to avoid having a channel running inside the wall of the housing.

Finally, FIG. 12 shows a sixth form of embodiment of the invention in which the adapter element 10″″ grips around the housing wall from the outside and so leads to a form-locking connection.

### LIST OF REFERENCE NUMBERS

1 Hot runner
2 Shut-off needle
3, 3′ Piston
4, 4′, 4″ Housing
5 Housing chamber
6 Housing chamber
7 Fluid inlet
8 Covering plate
9, 9′, 9″, 9′″ Covering element
10, 10′, 10′″, 10″″ Adapter element
11 Hollow cylindrical extension
12 Second fluid inlet of adapter element
13 Second fluid outlet of adapter element
14 Groove
15 Groove
16 First fluid outlet of covering element
17 First fluid inlet of housing
18 Stop face
19 Second fluid outlet of covering element
20, 21 O-ring
22 Bottom element
23 Cap, bell element
24 Channel
25 Cap bottom
26 Opening
27 Casing face
28 Groove
29 Recess
30, 30′ Projection
31 Hollow cylindrical element
32 Groove
33 Cylindrical element
34 Hot runner block
35 Groove
36 Fluid channel

1. Injection-moulding machine with a hot runner for feeding a plasticised melt into a mould, a shut-off needle for optionally closing or opening the hot runner, a piston which is connected to the shut-off needle and arranged in a housing with an opening and divides the housing into a first and a second chamber, and a covering plate with a first and a second fluid outlet, the housing exhibiting a first fluid inlet which is connected to the first chamber and a second fluid inlet which is connected to the second chamber and which are arranged in such a way that fluid can be transferred through the first fluid outlet of the covering plate into the first fluid inlet of the housing and fluid can be transferred through the second fluid outlet of the covering plate into the second fluid inlet of the housing so that fluid can be applied to both sides of the piston, the second chamber being arranged on the side of the piston facing the covering plate, characterised in that the second fluid inlet opening of the housing and the second fluid outlet opening of the covering plate differ in their cross-sectional areas and/or are located different distances from the axis of the shut-off needle, an adapter element being provided with a fluid inlet opening and a fluid outlet opening and configured in such a way that fluid provided by the covering plate through the second fluid outlet opening can be passed through the fluid inlet opening into the adapter element and through the fluid outlet opening from the adapter element into the second fluid inlet opening of the housing.

2. Injection-moulding machine according to claim 1, characterised in that the adapter element is connected to the housing in a form-locking manner in a direction perpendicular to the axis of the shut-off needle.

3. Injection-moulding machine according to claim 1 or 2, characterised in that the adapter element exhibits a base part extending essentially perpendicular to the needle axis and a hollow cylindrical extension extending essentially parallel to the needle axis, the extension being arranged at least partly inside the housing.

4. Injection-moulding machine according to claim 3, characterised in that the piston is arranged at least partly inside the extension.

5. Injection-moulding machine according to claim 3, characterised in that the second fluid inlet opening of the housing is formed by the inner wall of the housing and the outer wall of the extension.

6. Injection-moulding machine according to claim 5, characterised in that on its outside the extension exhibits at least one groove running essentially parallel to the needle axis.

7. Injection-moulding machine according to one of claims 1 to 2, characterised in that the second fluid outlet opening of the covering plate is located nearer the needle axis than the fluid inlet opening of the housing.

8. Injection-moulding machine according to one of claims 1 to 2, characterised in that the fluid inlet opening of the adapter element and the fluid outlet opening of the adapter element differ in their cross-sectional areas and/or are located different distances from the axis of the shut-off needle.

9. Injection-moulding machine according to one of claims 1 to 2, characterised in that the housing exhibits an essentially hollow cylindrical casing part and a bottom part, the bottom part exhibiting a passage for the needle.

10. Injection-moulding machine according to claim 9, characterised in that the bottom part exhibits an essentially cylindrical projection the outside diameter of which essentially corresponds to the inside diameter of the casing part.

11. Injection-moulding machine according to one of claims 1 to 2, characterised in that the covering plate, hot runner block and housing are arranged in such a way that at a first temperature of the hot runner block a gap remains between the housing and the covering plate and at a second temperature of the hot runner block which is higher than the first temperature the housing comes into contact with the covering plate in such a way that the covering plate closes the opening of the housing due to the thermal expansion of the hot runner block and/or housing, between the housing and the covering plate there being a flexible seal which is configured in such a way that the covering plate closes the opening of the housing in a position in which the covering plate and the housing are a distance from one another.
